(19) United States
(12) Patent Application Publication
(10) Pub. No.: US 2012/0203589 A1
(43) Pub. Date: Aug. 9, 2012

(54) Systematic Rule-Based Workflow Tasking and Event Scheduling

(75) Inventors: Timothy Eggena, Hamilton, GA (US); Steve Puckett, Orlando, FL (US); Jonathan Harmantas, NE Atlanta, GA (US); Robert Hale, Atlanta, GA (US)

(73) Assignee: NEXTGEN HEALTHCARE INFORMATION SYSTEMS, INC., Horsham, PA (US)

(21) Appl. No.: 13/060,148

(22) PCT Filed: Jul. 26, 2010
(86) PCT No.: PCT/US10/43196

§ 371 Date: Mar. 23, 2012

Related U.S. Application Data
(60) Provisional application No. 61/228,782, filed on Jul. 27, 2009.

(51) Int. Cl. G06Q 10/06

(52) U.S. Cl. 705/7.15

(57) ABSTRACT

A workflow management system is presented. The workflow management system can include a tasking module and rules engine. Users can interface with the tasking module to define tasks having rule-based task criteria. The rules engine monitors data associated with running a business, including data classified across business segments, to determine if an exception to the task criteria has occurred. If so, the tasking module can automatically generate an exception task to handle the exception and present exception tasks to one or more users.

This application claims the benefit of priority to U.S. provisional application having Ser. No. 61/228,782 filed on Jul. 27, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is workflow management technologies.

### BACKGROUND

There exist numerous billing and collection systems that offer ‘collector workbench’ type features with limited rules processing that generate exception based tasking, however, none are expansive enough to cover the entire workflow of a physician office beyond billing and collections. These older systems date back to earlier legacy technology running on mini and main-framed systems for both hospitals and physician offices. Most often, these modules would be external third-party products that interface with the core systems of the organization. Very rarely would an integrated tasking system exist within core legacy systems. As a result of the lacking integration, very few offer the additional features of automatically processing a task without manual user-intervention, and automatically completing tasks when the originating condition no longer exists.

In smaller business, including smaller medical practices, the above issues are further exacerbated by the use of individual pieces of third party software that a priori lack a capability to communicate with each other. Each software application targeting a different aspect of the business (e.g., administration, finance, clinical, electronic medical records, etc.) stores their respective classes of data in their own databases according to different formats. Each database can be considered an isolated silo of data. For example, one database might store accounting data from an accounting program, while a second database stores Electronic Medical Records (EMR) data. Consequently, integrating the different classifications of data into a fully integrated workflow management system is extremely difficult due to many reasons including differing database formats, confidentiality issues, or regulation requirements. Ideally a medical practice, or other business, would be able to fold their business related data in distinct data silos into the business' workflow task management system.

Others have put forth effort directed toward workflow systems supporting task management based on a business's data. For example, international patent application publication WO 01/80092 to Carley et al. titled “Method for a Health Care Solution Framework”, filed Apr. 13, 2010, describes a client—server architecture for storing files in a health care environment. Carley also discuses use of workflow management tools in environments when processes become complex.

U.S. patent application publication 2010/0076780 to Mahesh et al. titled “Methods and Apparatus to Organize Patient Medical Histories”, filed Sep. 23, 2008, discusses assigning a classification to clinical event medical report where the classification information can be used as a query to search a data store for the report.

U.S. patent application publication 2010/0043431 to O'Connor et al. titled “Impact Intelligence Oncology Management”, filed Aug. 14, 2009, discusses using administrative and clinical data to determine a cost efficiency and level of compliance with clinical guidelines.

U.S. patent application publication 2004/0172294 to Dahlin et al. titled “Integrated Virtual Consultant”, filed Nov. 26, 2003, describes use of an automated decision support system as part of a clinical workflow.

U.S. Pat. No. 7,716,072 to Green et al, titled “Integrated Medical Software System”, filed Mar. 29, 2007, describes a system that integrates aspects of a healthcare provider practice management.

Unless the context dictates the contrary, all ranges set forth herein should be interpreted as being inclusive of their endpoints and open-ended ranges should be interpreted to include commercially practical values. Similarly, all lists of values should be considered as inclusive of intermediate values unless the context indicates the contrary.

It has yet to be appreciated that the needs of a medical practice, or other small businesses, are different from those of larger, more sterile industrialized healthcare provider businesses. Data silos in a medical practice can be heavily cordoned from each other due to security, regulation, or database format issues, thus making an integrated workflow management system difficult to implement, especially in an environment where task or event schedules are dependent on the data stored in the different silos. However, as discussed below, a workflow management system can manage tasking by obtaining desired practice data even where the data is stored according to different classifications (e.g., administration, financial, clinical, EMR, etc) in disparate databases.

Thus, there is still a need for workflow management systems.

### SUMMARY OF THE INVENTION

The inventive subject matter provides apparatus, systems and methods in which one can utilize a workflow management system to generate new workflow tasks, including automatically generating exception tasks in response to exceptions raised from rule-based task criteria. The workflow system can include one or more databases storing practice data, where the practice data can be stored according to different classifications. For example, practice data can be classified as pertaining to administration, finance, clinical, Electronic Medical Records (EMR), or other types of data. In some embodiments, the various classes of practice data are stored in separate databases according class, possibly each class stored according to a different proprietary format. The workflow system preferably includes a tasking module in communication with the practice database, where the tasking module is configured to correlate practice resources (e.g., time, equipment, schedule, individuals, locations, etc.) with one or more rule-based task criteria. If the tasking module finds a resource match to the criteria, the resource can be allocated to the task. The workflow system can also include a user interface through which users, typically members of the practice, can define tasks by submitting rule-base task criteria or provide updates to the practice data. A rules engine can also be included with the workflow system to monitor a task's state relative to the practice data. Should analysis of the task's state reveal an exception to the task's rule-based criteria, an exception can be raise by generating an exception task, possibly a new task causing an action to be take to handle the exception. The tasking module can configure the user interface to present the exception task to a user. In some embodiments, the exception task takes the form of a new task, a recommended resource allocation, a notification, or other types of actions.

In embodiments where practice data is stored in isolated data silos according to a classification (e.g., administration, financial, EMR, clinical, etc.), the system can further include one or more workflow database adapters. Contemplated adapters can provide a translation service by converting proprietary database formats into other formats. Furthermore, the adapters can be configured to operate as a rules agent capable of monitoring one or more rules for the rules engine, where the adapter is local to the data of interest. Such an approach provides for securely monitoring sensitive data while retain confidentiality of the data without requiring the data to be exchanged over a network.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 presents an overview of a workflow management system.

FIG. 2 provides a schematic of a possible user interface allowing users to define task criteria.

FIG. 3 illustrates a possible configuration of a workflow management system allowing a rules engine to monitor practice data without exchanging the practice data over a network.

FIG. 4 provides an overview of a rules engine analyzing a task state with respect to the practice data.

FIG. 5 provides a schematic of a possible user interface configured to present exception tasks.

FIG. 6 illustrates examples of presenting task scheduling information.

### DETAILED DESCRIPTION

It should be noted that while the following description is drawn to a computer/server based workflow processing system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including increasing the efficiency of a task scheduling system or reducing human induce errors for managing a business's scheduling practices.

Although the following disclosure presents the inventive subject matter within the context of a medical practice, it is contemplated that the concepts can be generalized and applied to other types of business beyond healthcare.

### Overview

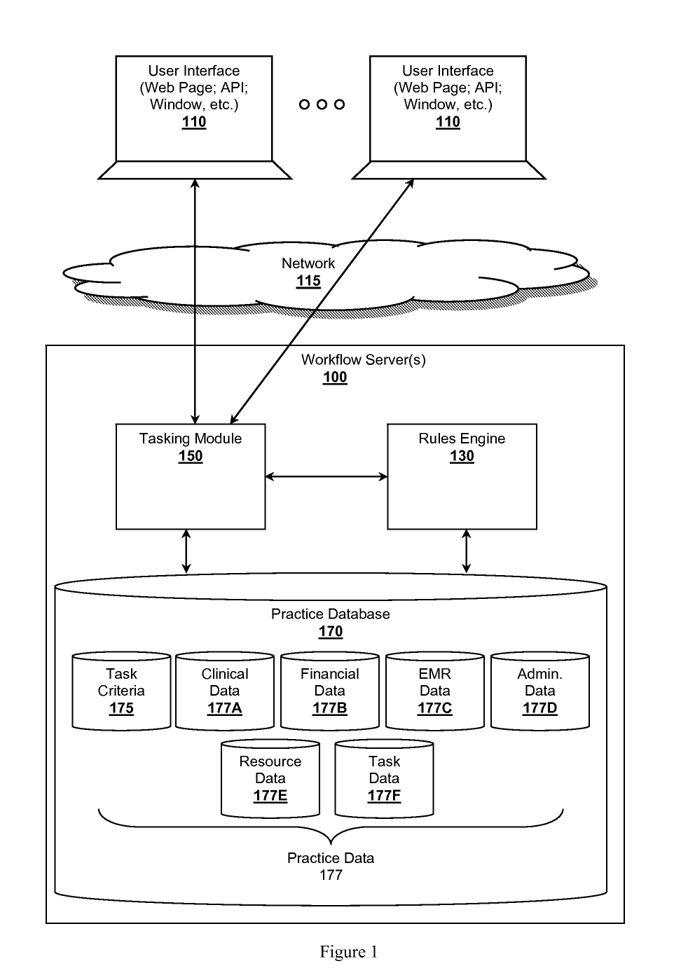

FIG. 1 presents an overview of a workflow management system within a medical practice where the system manages the practice's tasks. Contemplated workflow systems preferably include one or more of workflow server 100 supporting tasking module 150 and rules engine 130. Although workflow server 100 is illustrated as a single computing device where tasking module 150 and rules engine 130 functions as a software process, one should appreciate the tasking module 150 and rules engine 130 could be implemented as distinct servers in communication with each other. Workflow server 100 can also include practice database 170 storing practice data.

Workflow server 100 aids a practice by allocating resources to various tasks. In addition workflow server 100 can monitor one or more practice tasks to determine if any exceptions should be raised. If an exception is raise, the system can trigger an exception task to be generated, where the exception task preferably is directed to resolve the exception.

A task is considered to be a desired action representing one or more quanta of work. Tasks can require resources that should be allocated to the task and can include one or more actions. Tasks can be stored within practice data 177 as a data structure having one or more data members representing properties of the task. Properties can include resources (e.g., personnel, equipment, locations, time, etc.), metadata, names, pointers to other tasks (e.g., dependencies), classifications, or other desired attributes. Tasks can be classified according to different business segments: administrative, clinical, EMR, financial or other types of business segments. Actions of a task can be predicated on one or more rule-based criteria 175 that can be considered requirements for the task's actions to take place. Criteria 175 can also include one or more resource allocations that might be required or desired for a task. Example tasks can include sending invoices, scheduling patient visits, notifying clients of changes, reschedule events, updating calendars, or any other types of actions that a member of the practice can define.

The system can support a wide variety of tasks, where one preferred type of task includes an exception task, which is generated in response to detecting an exception to a task's defining criteria 175 as discussed below. The exception task can help resolve potential disruptions to the workflow. An event can be considered also be task, where resources are assigned for an amount of time (e.g., a surgery, a patient consolation, an office party, etc.).

Members of a practice, or other users, can gain access to workflow server 100 via one or more of user interface 110. User interface 110 can be considered to include a computer system instructed by workflow server 100 to present an interface. For example, workflow server 100 could include a server located on a network 115, a LAN for example. A user can direct a browser to a workflow server 100, which in turn instructs the user's browser to render a desired interface for the system. Naturally, user interface 110 could be realized according to any other known techniques as desired. Although user interface 110 is presented as a separate computing device from workflow server 100, it is also contemplated that user interface 110 can be located on workflow server 100.

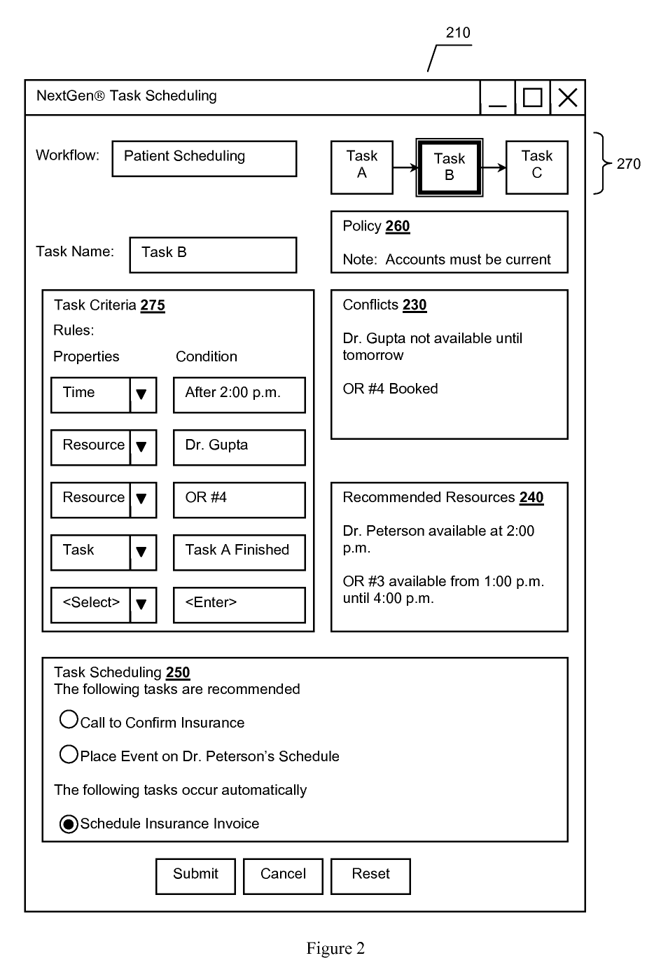

Members of the practice utilize user interface 110 to interact with tasking module 150. For example, members can submit rule-based task criteria 175 or other task defining properties via user interface 110. Furthermore, user interface 110 can be used to submit, update, or otherwise modify practice data. Additional details relating to user interface 110 can be found in the discussion relating to FIGS. 2, 5, and 6.

Workflow server 100 can comprise one or more computing devices configured to manage one or more aspects of a practice's workflow. As illustrated, in some embodiments, workflow server 100 operates as a platform for tasking module 150 and rules engine 130. In some embodiments, workflow server 100 can provide workflow management services as web service over the Internet.

Tasking module 150 is preferably communicatively coupled to practice database 170 configured manage one or more tasks within a practice's workflow. Tasking module 150 has multiple responsibilities including analyzing practice data 177, resource data 177E for example, to determine if one or more conditions rule-based conditions have been met as a function of task criteria 175. Tasking module 150 can also have responsibility for assigning or otherwise allocating resources to a task based on task criteria 175 automatically by correlating resource information in practice database 170 with rule-based task criteria 175. Once the conditions are met, tasking module 150 can initiate an action associated with the task. The action can include automatically scheduling or executing a task, possibly an exception task, or can present tasks to a user via user interface 110. The user can then determine if any recommended tasks should be scheduled.

Tasks can be classified according to different practice classification. Example classifications considered especially useful include administrative, financial, clinical, or EMR classifications. Other classifications can also be of value, including: regulatory, human resources, communications, or any other class. As mentioned previously practice data 177 can also be classified according to such classifications as represented by data 177A through 177F. Rules-based criteria 175 can comprise rules associated with practice data 177 belonging to different classifications that the classification assigned to a task.

Tasking module 150 preferably correlates properties associated with task criteria 175 with the properties associated with a practice's resource as represented by resource data 177E. When tasking module 150 finds an acceptable match with a resource, the resource can be allocated to contribution to satisfy the task's criteria 175. An additional responsibility of tasking module 150 includes taking action based exceptions to task criteria 175. For example, tasking module 150 can generate or even execute an exception task configured to address a raised exception.

Rules engine 130 can aid the tasking module 150 by monitoring one or more portions of practice data 177, especially data from different classifications, and tracking one or more sets of task defining criteria 175. Rules engine 130 can monitor practice data 177 by accessing practice database 170. For example, rules engine 130 can monitor practice data by submitting one or more queries to database 170, then evaluating returned result sets. Although rules engine 130 is illustrated as being separate from tasking modules 150 for clarity, it is specifically contemplated that the functionality of the two entities can be combined as a single entity.

Practice database 170 is illustrated as a single database storing multiple classifications of practice data 177. The practice data 177 is represented by clinical data 177A, financial data 177B, EMR data 177C, administrative data 177D, resource data 177E, and task data 177F, collectively referred to as practice data 177. Although only a few practice data classifications are presented, it should be appreciated that many more classifications could be included as necessary for management of the practice. One should also note that task criteria 175 can also be considered part of practice data 177, possibly representing a separate classification that can be brought to bear against task scheduling.

One should appreciate that practice database 170 could have a wide variety of structures. In some embodiments, database 170 can be a monolithic database storing all of the practice's data. In other embodiments, database 170 can comprise a distributed database including distinct data stores storing data from different classifications, possibly where the data stores on other computing devices. In such embodiments, financial data 177B can be located on an accounting server or service while EMR data 177C can be located remotely on a secured EMR service over the Internet.

### Practice Data Classifications

In some preferred embodiments, practice data 177 is ordered by classifications representative of at least the business segments of the practice. Example classifications include administrative, financial, clinical, or EMR. Record located with database 170 can be classified logically or physically.

Examples of logical classifications include incorporating classification information into a record itself. For example, a record can be tagged with metadata indicating the classification to which the record belongs. The metadata could be visible or non-visible via user interface 110 as desired or according to permissions, authorizations, or authentication. Metadata tags can be stored along with the record, possibly an XML record, or any other desirable record format.

Physical classifications represent a physical organization of practice data 177 according to desired classification. In some embodiments, the physical organization can be created via a file system directory structure where each class of data 177 can be stored in a different directory, possibly on the same store device (e.g., HDD, RAID, SAN, NAS, etc). In other contemplated embodiments, the physical organization can include physically distinct data silos, where each data silo comprises a distinct database that stores a different class of practice data 177.

Storing practice data 177 in different database can arise from circumstances where the practice utilizes different, distinct applications to manage data. For example, the practice might use an accounting package (e.g., QuickBooks™) to manage financial data 177B, while using NextMD™ to manage EMR data on a different computer system.

One should note that each record of practice data 177, including each task, can be classified in multiple classifications, even when physically stored. For example, a metadata index can be stored on workflow server 100, the index mapping each record in the physically distinct database to their corresponding classifications. The index mapping table can remain local to workflow server 100. Such an approach allows for tagging practice data 177 without requiring modification of records.

Task data 177F represents information about a task, possibly including a task name, task properties, task classification, resources allocated to a task, pointers to tasks, task dependencies, or even task criteria 175. Task criteria 175 are considered to include the rules governing a task, where the rules depend on the other classifications of practice data 177. Defining or scheduling tasks is discussed with respect to FIG. 2 below. One should further appreciate that task criteria 175 and task data 177F can also belong to the different classifications to indicate which business segment of a practice they belong. For example, a task might be classified as a financial task, possibly including the action of sending a notification to a patient via email regarding an outstanding balance. The rule-base task criteria 175 for the financial task could require accessing practice data from multiple classifications including administrative data 177D (e.g., a person to send the email), financial data 177B (e.g., current account balance), or possibly EMR data 177C (e.g., known risk factors).

Resource data 177E represents information about a practice's resources that can be allocated to a task, preferably by tasking module 150. Resource data 177E comprises records describing the resources available that can be allocated to a task. Resources can include individuals, locations, times or dates, rooms, equipment, or other items. As with other types of practice data 177, resource data 177E can also belong to various classifications. For example, a doctor that owns a practice could be considered to belong to the classifications of administrative and clinical.

### Task Scheduling

FIG. 2 illustrates a possible user interface 210 configured to allow a member of practice to submit task criteria 275 or to schedule one or more tasks. User interface 210 can be presented via a workflow application running on a local computing device or could be presented by directing a browser to a workflow server as referenced above.

In the example shown, a member of practice wishes to schedule a task within a workflow procedure 270. Displaying workflow procedure 270 aids the member of the practice by clearly indicating how a tasks or tasks fit within procedures of the practice. Naturally, workflow procedure 270 can be presented via user interface 210 at any time to member as desired, even when the user is entering practice data, or managing tasks in general.

The user has selected to schedule Task B in workflow procedure 270. In some embodiments the user is presented a template, as shown, from which they can scheduled or even define tasks. The user can also be presented with policy 260 to inform the user of possible requirements that could affect defining a task or managing a task. In this example, the user is entering a new task to be scheduled according to a “Patient Scheduling” workflow. Policy 260 indicates that a patient's account must be current before scheduling can take place. Although user interface 210 illustrates scheduling a task, a similar configuration can be used to define a brand new task, possibly based on an a priori defined template.

One should appreciate that displaying policy 260 or procedure 270 can be triggered based on previously defined tasks, which will become more apparent below.

The user is promoted to enter task criteria 275 defining one or more properties or conditions that are required for the task to take place. Properties can include a wide variety of information describing a task. As indicated properties can include a time, a resource, urgency, a priority, a weighting, or other attributes. Other properties can include a location, equipment, an action that can be taking by the tasking module, or any other properties. Although the example illustrates drop down menus for properties, one should appreciate that task properties can also be used-defined. One can consider properties as a metadata tag for a task or for its conditions.

Conditions represent rules that should be satisfied for the task to be scheduled, or for actions to take place when the practice data satisfies the conditions. In a preferred embodiment, a rules engine monitors the practice data to determine when the conditions are met, at which point the tasking module is informed and a proper action is taken.

The example shown illustrates several conditions including a time requirement indicating a patient can be scheduled only after 2:00 p.m. when Dr. Gupta or Operating Room (OR) #4 are available, and when Task A is complete (e.g., a task-complete criterion). Although the conditions are presented as natural language, it is contemplated that conditions can be formulated according to any desired format. In some embodiments, conditions can be submitted as programmatic code, while other embodiments provide a drag and drop interface allowing users to graphically define desired rules. Conditions or other rules can be combined together using various logical operators as desired (e.g., OR, XOR, NOT, AND, etc.). User interface 210 as depicted assumes each condition is required, thus there is an implied AND between each condition.

A rules engine can continuously monitor task criteria 275 relative to existing information within the practices data, even as a user enters task criteria 275. The rules engine can use the rule-based conditions to determine if exceptions to task criteria 275 exist, to generate recommendations for resource allocation, to recommend additional tasks, or to initiate a new task possibly as an exception to the criteria. Resource allocation can be determined based on resource information (e.g., properties, attributes, etc.) including a location, a healthcare provider, a priority, urgency, or even a payer (e.g., insurance company).

The rules engine analyzes the task's state with respect to the practice data currently available, even if the data is across multiple classifications. In presented example, the rules engine consults resource data to determine if Dr. Gupta or OR #4 is available, where both are considered resources. The rules engine determines that neither resource is available at the required time thus raising an exception and presents this information as conflicts 230. Conflicts 230 can be presented in numerous ways, possibly including highlighting recourse in red as it is entered into task criteria 275. When conflicts are found, the tasking module can be notified so that the tasking module can present the information to the user. One should appreciate that act of presenting conflicts 230 can be considered an exception task automatically executed by the system.

The rules engine can further analyze the practice data to determine, based on the rules-based conditions, possible recommendations. The rules engine can review the properties of the resources, tasks, or other records within the system to determine if there are alternative matches between rule-based task criteria 275 and conflicting resources. Based on the alternative matches, the rules engine can provide recommended resource 240. The act of generating recommendations can also be considered an exception task in response to resources being unavailable. For example, Dr. Gupta is not available. Dr. Gupta's resource information can be tagged with the property of “General Practitioner” or with other metadata. The rules engine can identify other doctors in the practice having the “General Practitioner” tag, where the other doctors, Dr. Peterson for example, is a match for the remaining task criteria 275. When matches are found, the tasking module can be notified so that the tasking module can present the information to the user.

As an additional example, OR #4 is booked while OR #3 is available. The rules engine has determined in response to the exception raise that OR #3 is an acceptable alternative. OR #3 can be determined to be acceptable through a comparison of properties outlined in task criteria 275, or properties of the resources. For example, the resource OR #4 can include multiple properties (e.g., location, availability, equipment list, etc). The rules engine can search for other operating room resources having acceptable equivalent properties to that of OR #4, or as a function of requirements dictated by task criteria 275.

The rules engine can also analyze task criteria 275, task data, or other information to determine if any additional actions should be taken as indicated by tasking schedule 250. In the example show, the rules engine notifies a tasking module of recommended tasks that might be worth performing or any tasks automatically executed. Recommended tasks can be offered as optional as shown; allowing the user to select which of the recommended tasks should indeed be performed.

One aspect of the inventive subject is considered to include monitoring the practice data across classifications to determine if there are exceptions to a task's rule-based task criteria 275. Exception tasks are generated by the tasking modules upon the rules engine detecting an exception raised as a function of rule-based task criteria 275 in view of the practice data, especially practice data across multiple classifications. When an exception does occur, the rules engine informs the tasking module of the exception to rule-based task criteria 275. Then the tasking module can perform an indicated action. For example, presentation of conflicts 230, recommended resources 240, or information within task scheduling 250 can be considered exception tasks generated in response to exceptions triggered by task criteria 275. One should appreciate that exception tasks can also have their own criteria; defining under what conditions the exception task should take place. Exception tasks can be brand new tasks, a priori defined tasks, recommendation on resource allocations, presentation of information, or other types of tasks.

More specifically, exception tasks can also apply directly to different business segments within the practice. Exception tasks can directed to administrative functions, clinical functions, financial functions, or other areas. For example, a patient's scheduled appointment can be changed automatically upon identification of new clinical data indicating the patient falls within a patient population that might be at risk due a prescribed medication that has recently become suspect. In this example, an exception task (i.e., rescheduling the appointment) is an administrative task that is generated upon detecting an exception to the scheduled appointment based on clinical data (i.e., medical report about medication) and on EMR data (i.e., patient records). All exception tasks are contemplated.

### Accessing Practice Data

To generate exception tasks, the rules engine monitors a task's state with respect to the practice data. When the rules engine and practice data exist on a single computing device and the practice data is readily available, accessing the practice data is straight forward and could take the form of a database query. When the practice data is stored in separated data silos, data access becomes more problematic.

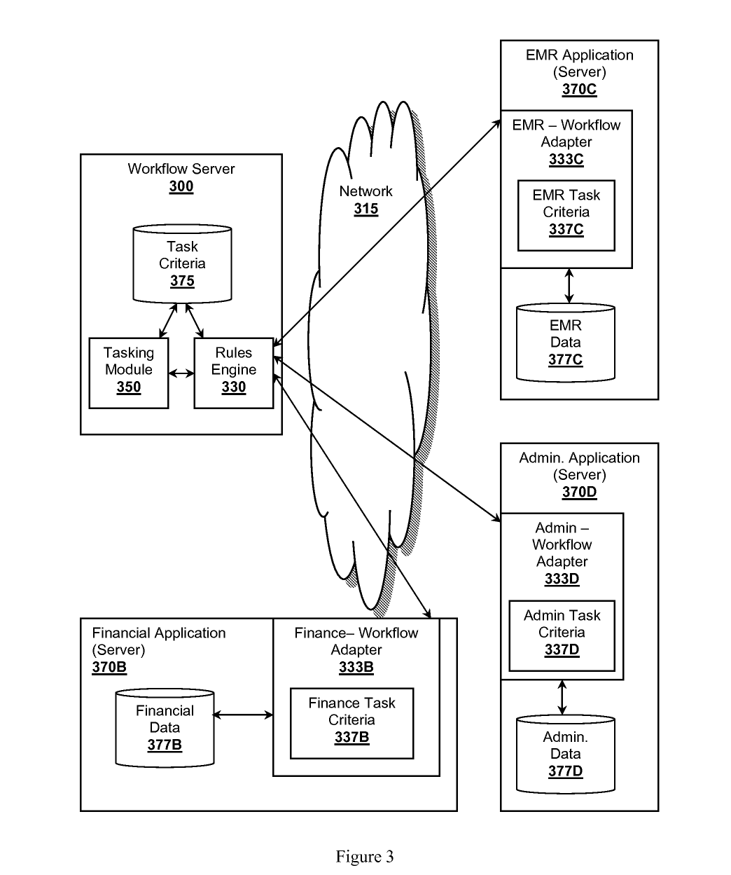

FIG. 3 illustrates a possible scenario where practice data is physically classified by storing different classifications on physically distinct servers or databases. Financial data 377B is stored on financial application server 370B, administrative data 377D is stored on administrative application server 370D, and EMR data 377C is stored on EMR application server 370C. Application servers 370B, 370C, and 370D are collectively referred to as servers 370, and classified data 377B, 377C, and 377D are collectively referred to as practice data 377. In an embodiment as shown, each class of practice data 377 can be stored in different databases according different database formats or schemas.

Although servers 370 are presented as distinct computing devices accessed by workflow server 300 over network 315, one should appreciate this example is simply exemplary of a scenario where the different data from different classes of the data 377 are stored separately, according to different formats. Other configurations are also contemplated. Naturally, the different data types could be stored in separate databases on a single computing device, or even in the same database according to different formats or schemas.

In the example shown in FIG. 3, it is possible that rules engine 330 or tasking module 350 might not be able to directly access each class of practice data 377 for various reasons. One reason of lacking direct access could be due to one or more restrictions enforced by application servers 370, possibly resulting from regulatory requirements to keep patient data secured and confidential. Another reason for lacking access to the data is that workflow server 300 might lack support for specific formats, protocols, or query command structures to interact with application servers 370. Consider EMR data 377C, EMR application server 370C would likely enforce regulatory requirements to protect a patient's confidentiality, or require that the data always remain local to EMR application server 370C. Rules engine 330 or tasking module 350 might lack authority or authorization to access directly EMR data 377C.

To resolve access issues, some preferred embodiments include one or more adapters that can be integrated on to application servers 370 as shown, or within workflow server 300 (not shown). Adapters 333B, 333C, and 333D are collectively referred to as adapters 333.

Adapters 333 are preferably configured to provide an access interface (e.g., API, URLs, web services, etc.) between rules engine 330 or tasking module 350 and practice data 377. Each of adapter 333 can be configured to convert from the specific data formats, schemas, or protocols used by application servers 370 to those used by workflow server 300. In such an embodiment, workflow server 300 can utilize a common intermediary format for all data exchanges, possibly based on a serialized format. For example, all objects within the system (e.g., tasks, resources, financial data, etc.) can be serialized based on XML or other acceptable data format. Adapters 333 can serialize, or otherwise convert data, using known techniques. Such an approach resolves accessing or exchanging data in a heterogeneous database environment.

It is also contemplated that adapters 333 can also provide for local access (e.g., local to servers 370) to practice data 377 without allowing the data to be exchanged with remote computing devices. For example, adapters 333 can be outfitted with a rules engine agent capable of locally monitoring practice data 377 to determine if exceptions to a task's criteria occur. It should be appreciated that each agent only requires sufficient information for its specific class of data. Consider EMR application server 370C, which might restrict access to EMR data 377C. Rather than granting authorization to workflow server 300 so that rules engine 330 can monitor EMR data 377C, EMR—Workflow adapter 333C can comprise a rules agent that stores EMR task criteria 337C. EMR task criteria 337C represents task criteria that specifically relate to EMR data 377C. The rules agent then analyzes the state of a task by comparing EMR data 377C to EMR task criteria 337C. When an exception arises, or other satisfying condition is met, the rules agent communicates the exception information back to rules engine 330. Rules engine 330 aggregates all the exception information from other adapters 333 (e.g., Finance—Workflow adapter 333B, Admin—Workflow adapter 333D, etc.) to generate an exception task via tasking module 350 where the exception task is generated as a function across multiple practice classification.

The inventive subject matter is considered to include providing adapters that are task criteria aware, especially aware of task criteria specific to classifications of practice data for which the adapter is responsible. One should note that the practice data remains local in its data silo while servers 300 and 370 only exchange task criteria or exception information. Thus, the confidentiality of the data is maintained.

### Task Monitoring and Generating Exception Tasks

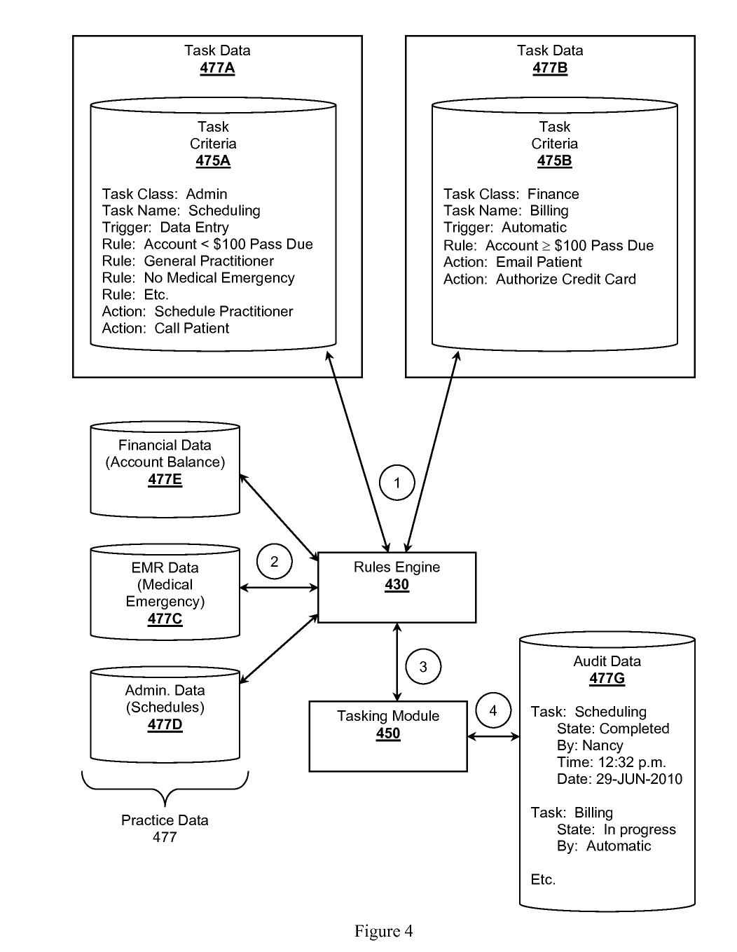

FIG. 4 provides an example overview a possible process by which rules engine 430 analyzes a state of one or more tasks and causes an exception task to be generated. Although rules engine 430 and tasking module 450 are presented as separate entities, one should appreciate that their functionalities can be combined into a single entity. Task data 477A represents data associated with a scheduling task and includes task criteria 475A comprising rule-based conditions that should be met before action is taken on the scheduling event. Task data 477B represent data associated with an exception task and comprises task criteria 475B outlining rule-based conditions by which a billing task should be scheduled or executed.

At step 1 rules engine 430 acquires task criteria 475A possibly in response to a patient calling for an appointment. Rules engine 430 evaluates the rule based criteria to determine if conditions are satisfied by consulting the various classes of practice data: financial data 477E for account balance, administration data 477D for available general practitioners, and EMR data 477C for medical emergencies. If rule based task criteria 475A are met, tasking module 450 can allocate necessary resources for the task by matching resources properties to those of the task or task criteria 475A.

One should appreciate that practice data is considered a dynamic quantity that can change at any time. Therefore, at step 2 rules engine 430 analyzes the task's state with respect to practice data 477. In the example provided, rules engine 430 discovers at a point in time before the schedule appointment that the patient's account balance has risen above $100. In parallel, rules engine 430 continues analyzing the billing task's state with respect to practice data.

An exception can be triggered when one or more rule-based conditions of task criteria 475A dictate. It should be appreciated that an exception can be raised when a condition is satisfied by practice data 477, when the condition is not satisfied by practice data 477, or when conditions change state between satisfied and not satisfied. It should be further appreciate there is a difference between satisfying conditions within task criteria 475A and satisfying conditions of an exception tasks. Consider the discussion above regarding the first rule-based condition of task criteria 475A, when the patient's account balance is greater than $100, which fails to satisfy the rule, an exception raised.

At step 3, rules engine 430 notifies tasking module 450 that an exception has been raised due to the accounting issue, which causes tasking module 450 to engage the billing task. Tasking module 450 can then allocate a resource to call the patient and to obtain credit card authorization before the scheduled appointment. Tasking module 450 can provide recommendations for additional tasks that should be scheduled or tasking module 450 could automatically execute actions associated with a task (e.g., send email to a patient).

At step 4, tasking module 450 can also log audit data 477G to track tasks. As shown, the scheduling task has been completed while the billing task is in progress. Such information can then be presented back to members of the practice as an audit report. Audit reports can comprise employee evaluation reports, regulatory compliance reports, or other types of reports. Audit reports can present tasks by their properties possibly by task weighting, priority, data, or other attributes.

The scheduling task and billing exception task can be directly linked or indirectly linked. An example of directly linking tasks includes binding an exception task to a task in a suitable fashion. For example, task criteria 475A could include an exception task pointer or other identifier bound to one or more rules. When rules engine 430 discovers that one of the rule-based conditions is satisfied, or even not satisfied, rules engine 430 can provide the exception task identifier for the rule(s) to tasking module 450. Tasks can be indirectly linked through inference by rules engine 330 as opposed to having an exception task identifier stored with task data 477A or 477B. Rules engine 330 can infer the tasks are correlated by analyzing properties associated with task criteria 475A and 475B. In the example, shown rules engine 330 determines the two tasks are correlated by finding complementary rules. Naturally, other properties can also be used to infer a relationship including metadata tags, classification information, location information, resource information, time information, or other types of data.

From the above discussion the reader should appreciate that rules engine 330 can have multiple responsibilities. Rules engine 330 can identifying that an exception should be raised as triggered by task criteria 475A. Once an exception has been raised, rules engine 330 can determine which, if any, exception tasks should be schedule automatically or manually. Rules engine 330 can generate the exception tasks via tasking module 450 as desired.

Rules engine 430 can be configured to analyze a task's state with respect to practice data through various methods. One possible approach is for rules engine 430 to periodically query or otherwise poll the databases storing practice data 477 to determine if the practice data 477 indicates an exception should be raised. Another approach includes installing an exception hander or listener within the database that monitors changes to the practice data 477 as the data changes. When the exception handler or listener detects a change of interest, it can indicate the change has occurred to rules engine 330 for further handling. In some embodiments, rules engine 430 detects an exception in real-time (e.g., at least within 30 seconds) relative to changes in the practice data 477. Depending on the structure of the practice's database, each approach has advantages and disadvantages. For a system having data silos, use of exception handler or listeners is considered more preferable to reduce message passing overhead. Regardless of the approach taken, rules engine 330 can be configured to continuously monitor practice data 477. Upon detection of an exception, rules engine 430 notifies tasking module 450. Tasking module 450 can take further actions.

### Task Alerts, Recommendations, and Notifications

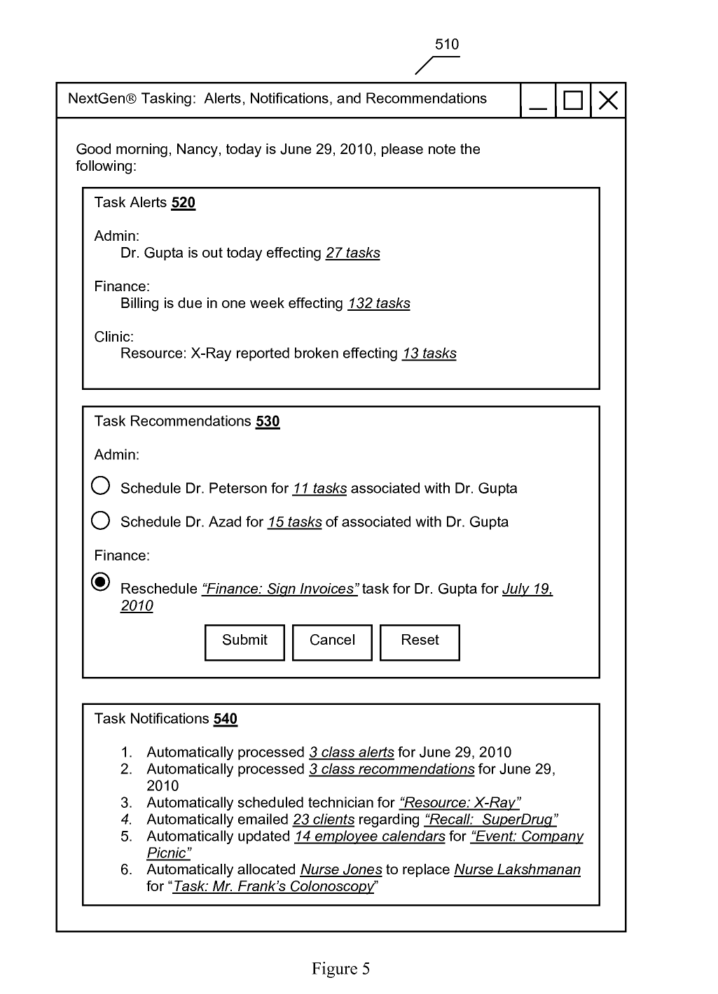

FIG. 5 illustrates possible exception task handling capabilities of a tasking module as indicated via user interface 510. When a exception is raised and the tasking modules is required to generate an exception task, the tasking modules informs users of the workflow system about the exception task in numerous ways, preferably depending on the type of exception.

In some embodiments, an exception task can comprises task alerts 520 based on changes observed within the practice data across multiple classifications. As shown in the example, from an administrative perspective, Dr. Gupta is out ill today, which causes the system to recognize that 27 tasks are affected due to the exception raised by Dr. Gupta's absence. The action of presenting the administrative alerts is an exception task triggered by the task criteria of the 27 tasks to which Dr. Gupta has been allocated. Naturally, task alerts 520 can be organized according to classifications as desired. User interface 510 presents three classifications (e.g., administration, finance, and clinical) from among the many possible classifications.

Tasking modules can also provide task recommendations 530 as an exception task where task recommendations can also be presented according to the practice's classifications. When an exception is raised, the tasking module or rules engine can seek solutions to the exceptions by correlating resources or other tasks that could result in resolution of the raised exception. In the example shown, the system has identified that Dr. Peterson and Dr. Azad are optionally available for allocation to Dr. Gupta's tasks. While the allocations of these resources are presented as being optional, in some embodiments the system can automatically allocate the resources. Also note the system has rescheduled one task for Dr. Gupta likely because he is the only person (e.g., has signature authority) for the desired task.

The reader should be aware of a potentially subtle point. More than one exception task can be generated when an exception has been detected. In the example shown with respect to task recommendations 530, multiple exceptions tasks are generated. A first set of exceptions tasks are automatically executed by the system to identify or present potential solutions to any raised exceptions. A second set of tasks are generated, but not necessarily executed immediately, where the second set of tasks are presented as optional tasks that can be confirmed by the user.

Tasking modules can also present task notifications 540 providing information about tasks, where the information can include a task's name, state, progress, classification or other information. Within user interface 510, task notifications 540 provide an indication of various tasks automatically executed by the workflow system. Note the first and second notifications indicate that exception tasks have been executed to provide task alerts 520 and task recommendations 530.

User interface 510 can also indicate that additional information is available for the task alerts 520, task recommendations 530, or task notifications 540. In the example, text displayed in italicized underlined font indicates additional information is available. Should the user click on the “27 tasks” in the admin alert of task alerts 520, the user can be presented with a list of the effected tasks. Such an approach allows the user to gain additional information about tasks or to possibly modify a task as desired.

### Additional Considerations

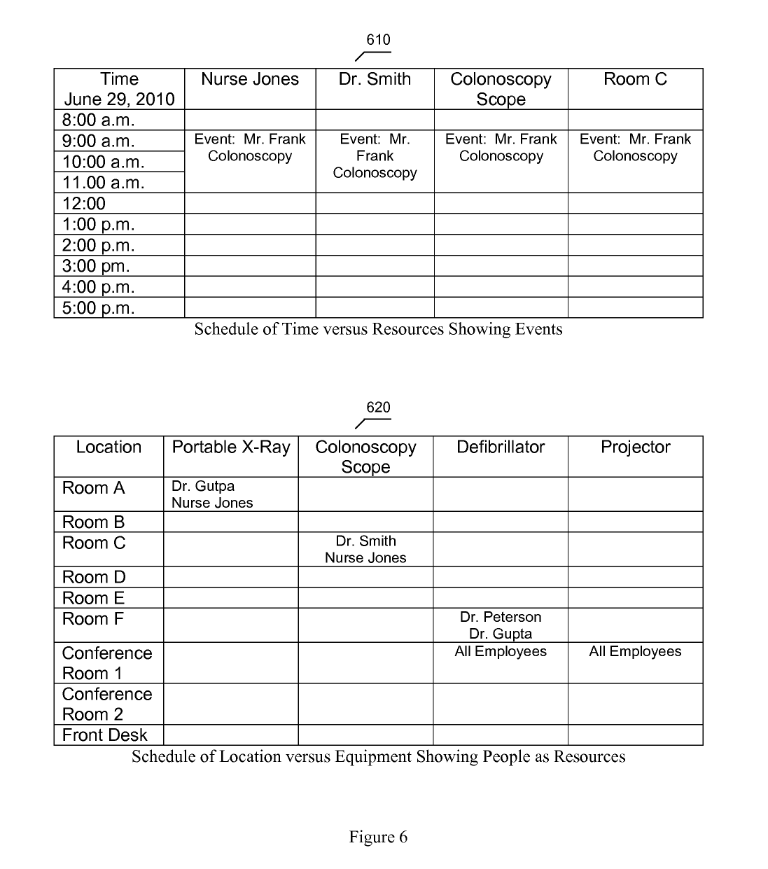

One can consider a task has being a record comprising multiple properties in the record describing the task, the properties including names, events, times, locations, personnel, equipment, state, task criteria, or other types of information. In a very real sense, a task can be considered an N-tuple of values. The workflow system can track how resources (e.g., equipment, personnel, locations, time, etc) are allocated across multiple tasks to aid members of the practice in managing workflows. More specifically, a user interface can be configured to present one type of task property versus another type of task property to show how a third type of property relates or is bound to the other two. FIG. 6 presents two examples of presenting properties in a tabular form.

Table 610 presents a schedule showing time of day versus personnel and how the personnel are allocated to various tasks. The resources Nurse Jones, Dr. Smith, a colonoscopy scope, and room C have been allocated to an event-based task labeled “Event: Mr. Jones Colonoscopy.”

Table 620 provides a further example of a schedule showing how alternative properties can also be presented. Table 620 presents location versus equipment and shows which personnel are associated with the location and equipment. Note a defibrillator is assigned to Dr. Gupta and Dr. Peterson in Room F, possibly for introduction to the machine before a training session with all the employees in Conference Room 1.

Table 610 and 620 illustrate that task resource allocations can be presented across multiple tasks as a schedule for a first task property versus a second task property. It is also contemplated the information can be presented in a non-tabular form. For example, the information can be presented graphically or as a chart.

Although above disclosed techniques lacks discussion with regard to task feedback, one should appreciate that the contemplated workflow system has an inherent feedback loop. A tasking module can automatically manage tasks or resources based on raised exceptions, which in turn causes exception tasks to be schedule. Resolution of the exception tasks likely affects the practice data, which causes the rules engine to reanalyze a task's state with respect to the define task's criteria. The inventive subject matter is considered to include the concept of a workflow management system capable of converging on resource allocation through generating exception tasks.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A medical practice workflow system, the system comprising:
a practice database storing practice data according to multiple practice classifications;
a tasking module communicatively coupled to the practice database and configured to allocate automatically resources to a task by correlating resource information in the practice data with rule-based task criteria;
a user interface communicatively coupled to the tasking module, through which a member of the practice is able to submit the rule-based task criteria, the rule-based task criteria capable of triggering an exception task;
a rules engine configured to analyze a state of the task with respect to the practice data across multiple classifications, and further configured to generate the exception task via the tasking module upon detecting the exception as function of the rule-based task criteria and the practice data; and
wherein the tasking module configures the user interface to present the exception task.

2. The system of claim 1, wherein the task comprises a task classified according to a practice classification drawn from the group consisting of a clinical class, an administrative class, a financial class.

3. The system of claim 2, wherein the rule-based task criteria comprises rules associated with practice data belonging to a different classification than a task classification for the task.

4. The system of claim 1, wherein the database comprises database adapters configured to exchange practice data between one of the tasking module, the rules engine, the user interface, and a third party database separating the classified practice data.

5. The system of claim 1, wherein the rules engine is configured to monitor the task with respect to changes in the practice data in real-time.

6. The system of claim 1, wherein the rules engine is configured to monitor the task state with respect to changes in the practice data by polling the practice database.

7. The system of claim 1, wherein the user interface is further configured to obtain user defined tasks and practice data.

8. The system of claim 1, wherein the rule-based task criteria comprises a task-complete criterion.

9. The system of claim 8, wherein the tasking module is configured to reallocate resources upon satisfaction of the task-complete criterion as the exception task.

10. The system of claim 1, wherein the tasking module is further configured to schedule an event as the task based on the practice data.

11. The system of claim 1, wherein the tasking module is configured to allocate resources based on at least one of a location, a provider, a priority, and a payer.

12. The system of claim 1, wherein the tasking module is further configured to store an audit trail of tasks within the practice database.

13. The system of claim 1, wherein the tasking module is further configured to present to a user via the user interface at least one of a policy and a procedure relating to the task.

14. The system of claim 1, wherein the tasking module is configured to present to a user via the user interface task resource allocations.

15. The system of claim 14, wherein conflicts of task resource allocations are highlighted.

16. The system of claim 14, wherein task resource allocations are presented across multiple tasks as a schedule of a first task property versus a second task property.

17. The system of claim 1, wherein the exception task comprises a recommendation on resource allocation.

18. The system of claim 1, wherein the exception task comprises a new task.

19. The system of claim 18, wherein the rules engine is further configured to execute the exception task.
